(19) United States
(12) Patent Application Publication
(10) Pub. No.: US 2009/0117908 A1
(43) Pub. Date: May 7, 2009

(54) MOBILE COMMUNICATIONS

(76) Inventors: David E. Hughes, Ipswich (GB); John C. Lee, Horham (GB)

Correspondence Address: NIXON & VANDERHYE, PC, 901 NORTH GLEBE ROAD, 11TH FLOOR, ARLINGTON, VA, 22203, US

(21) Appl. No.: 12/299,969

(22) PCT Filed: Apr. 18, 2007
(86) PCT No.: PCT/GB07/01404

§ 371 Date: Nov. 7, 2008

(30) Foreign Application Priority Data
May 24, 2006 (EP) 06252678.5

(51) Int. Cl. H04W 36/00; H04W 40/00

(52) U.S. Cl. 455/440; 455/445

(57) ABSTRACT

A mobile handset is capable of establishing communication through a cellular network (2) and a local access system (7, 8, 27), which has an interface (9) with the cellular network to allow the handset's presence to be logged by the switching centre of the cellular system (2). If the handset requires a handover between local access systems (7, 27), this is provided for by a handover processor (97) in the interface (9), instead of in the mobile switching centre (2). This allows the connection between the mobile access bridge (9) and the mobile switching centre (2) to remain unchanged, and sessions are still routed by the mobile switching centre (2) to the mobile access bridge (9), which emulates a base site controller. Thus, in the event that a handset makes such a transition, the mobile switching centre (2) has no visibility of that handover, and the same network identity can be used for the handset (1), by way of the mobile access bridge (9), throughout the time the handset is connected to the local wireless connections rather than directly to the cellular network through a base station (21). This allows network facilities that are only available through the access networks (7, 27), but not through the cellular system (2), to be maintained seamlessly during the handover.

This invention relates to mobile communications systems. Mobility in this context means the provision of the capability for a user to make contact with a communications network from a variety of different locations, so that the user can exchange information with other parties. The information may be in the form of speech, as in conventional telephony, or data representing visual material such as text or graphics, or a combination such as audio-visual material. Communication may be one-way or two-way. If a wireless connection is used and the terminal equipment is sufficiently. portable, a mobile user may exchange information with other parties whilst he is motion.

Many mobile communications systems have been developed, ranging from very large scale systems using satellites, to termination points in the fixed network with provision for a user to connect a terminal (often a laptop computer) thereto, to gain access to the network by entering a user identity and network access code. Intermediate between these extremes fall systems such as the various cellular telephone networks, wireless local area networks (WLAN), using the “WiFi” (IEEE 802.11) standard, short-range systems that operate ad hoc networks such as “Bluetooth” (RTM), and “cordless” arrangements in which a single short-range wireless base station, connected to the public switched telephone network (PSTN), allows a user with a wireless handset to move around within range of the base station.

All of these wireless systems allow a user terminal to communicate with a network without the need to form a physical “wired” connection, whether using real wires or optical fibres. This simplifies installation of equipment, as a single wireless hub can readily serve several different user terminals at the same time, or new terminals can replace older ones without the need for complex installation. Wireless connection also allows a user more flexibility in where the terminals may be located, and in particular several relatively widely spaced terminals can be accessed using the same hub without the need for lengthy wiring runs.

In larger systems more than one fixed base station may be required in order to give adequate coverage, with the base stations co-operating to allow a given user terminal to be recognised by any of the base stations when it first attempts to establish contact or moves from the range of one of the base stations into the range of another. Therefore, a communications session is established between a given user terminal and the underlying network to which the base station is connected, and the session may be continued through a second base station should the terminal move out of range of the one it first makes contact with.

Generally a user has to select the type of network most suitable to his current requirements: for example a cellular telephone may be appropriate for making a voice call in the street, but the bandwidth is limited and call quality is relatively poor compared to a high-bandwidth “WiFi” wireless access connection, which may be more appropriate if there is much data to be handled and Wi-Fi coverage is available.

In general, a user needs to have a separate user identity, and a separate terminal, for each network he subscribes to. This can be inconvenient both for the user in question and for anyone trying to contact him. A number of attempts have been made to ameliorate this. For example, dual-mode handsets exist, which are capable of operating on more than one type of connection, although they need separate subscriptions for each mode. Systems are now coming into existence in which a handset may register with the local wireless system when such a system is available with which the handset is compatible, whilst when such a system is not available it registers directly with a cellular network. The local wireless system has an interface with the cellular network arranged such that the local wireless system emulates a base station of the cellular network. This allows handover to be performed during a call, using the cellular switching function of the cellular network, so that incoming calls can be routed to the handset even when it is connected to the local wireless network.

In this existing system, should a handset move out of range of a local wireless network, it will initiate a handover to the cellular network. Should the handset then move into range of a second local wireless network, handover to that second network can be effected. The cellular network interacts with both local networks as if they were ordinary cellular base stations. However, in the existing system the cellular network has no direct indication of whether the handset is in range of any local network. It merely responds to handover instructions initiated by the local network. When a handset moves out of range of a local network, it is therefore necessary to transfer control to the cellular network, even though the handset may already be within range of a second local wireless network at the time it effects a handover from the first one. In such a case, a second handover will then take place. This process can cause difficulties, for example if there are capacity problems on the cellular network the session may be dropped. The requirement for the user to be connected, albeit only for a brief period, to the cellular network may not always be possible to satisfy, particularly if the handset is at an indoor location, and even if it is possible, it will incur call charges. During that interim period communication would also be subject to any limitations that the cellular network may have, such as a lower bandwidth or a difference in the facilities available.

A system is described in International Patent Specification WO02/093811 in which handover is controlled by a unit which interfaces with the cellular network, but allows direct handover between access points if their range overlaps sufficiently to make this practicable. However, such handovers are still under the control of the cellular system, and every handover has to be notified to the control centre of the cellular network.

According to the invention, there is provided a telecommunications switching system comprising location and switching means for routing communication sessions to and from a mobile terminal by way of an access network, wherein the access network comprises a plurality of access systems, each of which may be accessed by the mobile terminal,

interface means for communicating with a location and switching means of an associated network to report the establishment or cessation of a sessions between mobile terminals and the access network,

and handover means associated with the location and switching means to allow a mobile terminal to transfer from co-operation with one of the access systems directly to co-operation with another of the access systems, wherein the handover means of the access network operates independently of the associated network.

The invention also extends to a method of operating a telecommunications switching system such that communications sessions may be routed to and from a mobile terminal identity either by way of an access network or by way of an associated network,

wherein the access network comprises a plurality of access systems and a mobile terminal may be transferred, under the control of the access network, from co-operation with one access system to co-operation with another access system,

wherein the establishment or cessation of a session between a mobile terminal and the access network is reported to the associated network through an emulation means,

and wherein transfer between access systems during such a session is under the control of the access network and transparent to the associated network.

By allowing the handover process to take place within the access network, interaction with the associated network can be minimised, and in particular without needing to have visibility of how the user terminal is connected to it. Handovers between local wireless access terminals are handled without any involvement of the cellular system at all. In particular, handovers between access points of the access network are possible even when the mobile terminal is not in range of a base station of the associated network.

The interface means may be arranged to connect sessions between the associated network and a terminal connected to the access network, or to connect sessions between the access network and a terminal connected to the associated network, depending on the network to which sessions to that terminal are initially directed to—which depends on which network the user's directory number is allocated to.

Two embodiments of the invention will now be described by way of example, with reference to the drawings, in which

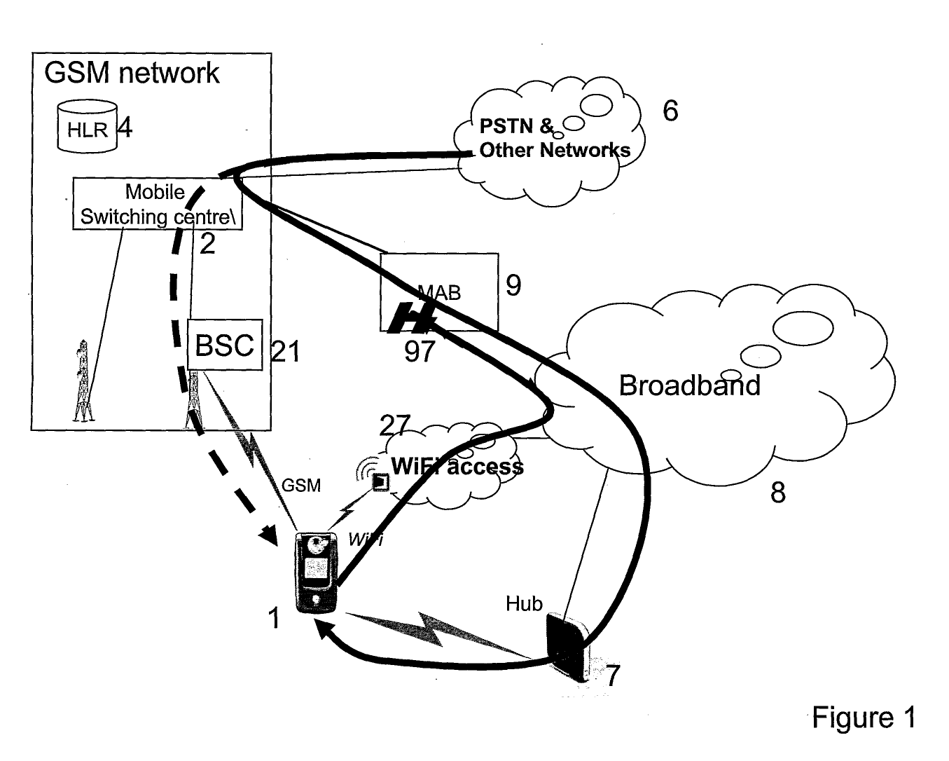

FIG. 1 is a schematic diagram of a first communications system embodying the invention.

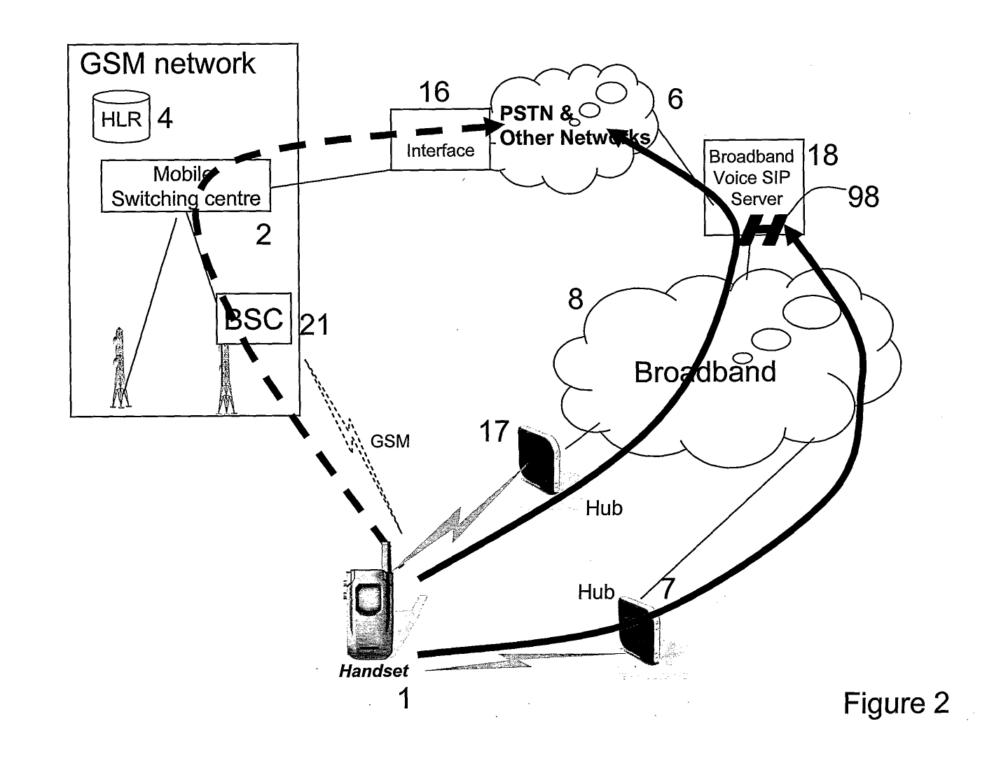

FIG. 2 is a schematic diagram of a second communications system embodying the invention.

FIG. 1 depicts a mobile telecommunications handset 1 having a capability to communicate both with a public cellular communications network 2, 4, 21 and with a local wireless access hub 7. The local wireless access may use any suitable means, such as the WiFi (IEEE 802.11) standard, an ad hoc low power network system such as “Bluetooth” (RTM), or using the same cellular telephony protocols as the public network 2, 4, 21, but using a reserved frequency band not available for general use by the cellular operator 2.

Communication with the cellular network operates in conventional manner: the location of the handset—that is to say the identity of the base site controller 21 with which the handset is currently co-operating—is stored in a register 4. Whilst in communication with the base site controller 21, sessions can be routed through a mobile switching centre 2, as indicated by the dashed line. The mobile switching centre 2 is arranged to route sessions through the public switched network. Incoming sessions are routed to the switching centre 2 which retrieves the handset's current location from the register 4 in order to identify the base station 21 to which sessions should be routed. Should the handset move into range of a different base station, this fact will be detected by the new base station and the register 4 is then updated accordingly.

The handset 1 is also capable of communicating with a local wireless access system 7, through which it has access to a digital packet switched network 8 such as the “Internet”. Typically this offers higher bandwidth and potentially other features, and thus in locations where both facilities are available the handset selects the local wireless access system 7. In order to allow handover between the two systems 21, 7 during the course of a session, and to allow incoming sessions to be routed to the handset, an interface unit (mobile access bridge) 9 is provided, through which all sessions to and from the handset 1 by way of the hub 7 are routed. This interface 9 co-operates with the mobile switching centre 2 by emulating another base site controller—it reports when it has seized or relinquished control of the handset 2, allowing sessions to be routed through it to and from the switching centre 2, in the same way that a normal cellular base station would behave.

In the prior art system, when a handset 1 moves from the region in which it can communicate with a first wireless access point 7, the access bridge 9 would report this to the mobile switching centre and register it with the cellular base station 21 with which it is in contact. Should the handset now be able to establish contact with another local access system 27, a session has to be re-established with the mobile access bridge 9 and a further handover, from the BSC 21 to the access bridge 9, effected in the mobile switching centre 2.

In the arrangement shown in FIG. 1 the present invention is embodied by providing for handover in such circumstances to take place in the mobile access bridge 9, instead of in the mobile switching centre 2. Whilst connected to a first access point 7, the handset may find it also has access to the data network 8 through a second access point 27. Whether a handover should be initiated may be determined by co-operation between the handset I and the access bridge 9 based on one or more criteria such as signal strength, bandwidth, congestion, availability of facilities, etc. Based on these criteria, a handover function 97 determines when the handset should be handed over to the access point 27, and sets up a link to do so. However, the connection between the mobile access bridge 9 and the mobile switching centre 2 remains unchanged, and sessions are still routed by the mobile switching centre 2 to the mobile access bridge 9, emulating a base site controller. Thus, in the event that a handset makes such a transition, the mobile switching centre 2 has no visibility of that handover, and the same network identity can be used for the handset 1, by way of the mobile access bridge 9, throughout the time the handset is connected to the local wireless connections rather than directly to the cellular network through a base station 21.

The embodiment of FIG. 2 is based on an alternative interface arrangement between the cellular and local access systems. This interface arrangement is described in the applicant's co-pending application filed on the same date as the present application, and claiming priority from European patent application 06252679.3.

In the arrangement shown in FIG. 2, the fixed network 6 is provided with an internet-based telephony platform 18. This platform allows sessions to be connected between the PSTN 6 and the digital packet switched network 8, and provides the necessary protocols such as “Voice over Internet Protocol” (VoIP) to allow interfacing between them. This allows sessions from the PSTN 6 to be routed to a suitably-equipped handset 1 by way of the digital packet switched network 8 and a local wireless access hub 7. Thus a routing for such sessions is provided which does not make use of the cellular network 2, 4 and dispenses with the mobile access bridge 9 shown in FIG. 1.

In this arrangement, the user handset 1 has a directory number associated with the PSTN 6 rather than the cellular network 2, and so sessions directed to the user can be routed to the handset without any involvement of the cellular network. The cellular system 2 is therefore only involved in sessions where the “final drop” part of the session requires use of the cellular access system 21, typically because the handset is not within range of a local wireless access system 7. The interface 16 is designed to emulate another cellular network, so that the real cellular system 2 can operate normally, interacting with the fixed network 6 in which initial handling of incoming sessions is performed. Unlike the embodiment of FIG. 1, where the cellular network 2 is the home network with which the handset's directory number is associated, in the embodiment of FIG. 2 the home network is the fixed network 6.

Should the handset 1 be out of contact with its associated local wireless access system 7, the handset will seek a hand-over to the cellular network 2, and will become registered as a “roaming” handset currently connected to the cellular network 2. The cellular network 2 reports this location information to the session server 18, as it would to the HLR of any normal visiting handset, so that incoming sessions to the PSTN 6 destined for the user 1 can be routed by way of the cellular network, as shown by the dotted line in FIG. 2. When in cellular mode, outgoing sessions are handled as conventional cellular telephony calls, in the manner shown in FIG. 1.

When contact with a local wireless access system 7 is re-established, the contact information is passed to the session server 18, which reports to the cellular network 2 that a handover has occurred. The interface between the session server 18 and cellular network 2 is configured such that the session server 18 emulates a base site controller of the cellular network 2. The cellular network therefore operates conventionally, with the handset 1 logged as operating through this quasi-base site controller. Sessions originating within the cellular system 2 which are destined for the user 1 can therefore be routed by the cellular system, either directly when the handset 2 is connected thereto, but more otherwise to the session server 18 by way of the interface 16. All other incoming sessions for the handset arrive through the PSTN 6 and are routed by the session server 18 to the access connection 7. However, the cellular system would continue to register the presence of the handset as co-operating with the quasi-base station 18, even though it would have no visibility of most sessions being made to and from the handset 1.

It should be noted that the mobile network 2 may be able to detect the presence of the handset 1, even when the handset is not communicating with it. However, the handset determines which access system it gives precedence to—in this case the local wireless access system—and only roams to another network (namely the cellular network 2) if no local wireless system is available.

In the arrangement shown in FIG. 2 the present invention is embodied by making provision for handover to take place in the session server 18. Whilst connected to a first access point 7, the handset may detect that it also has access to the data network 8 through a second access point 17. As in the embodiment of FIG. 1, whether a handover should be initiated is determined by co-operation between the handset 1 and the access bridge, from which a handover function 98 determines when the handset should be handed over to the access point 17, and sets up a link to do so.

Incoming sessions are routed to the server 18, and thence to the access point 7, 17 with which the handset I is currently registered. The interface 16 emulates a single base station, and therefore the mobile switching centre 2 has no visibility of such transfers, nor of any sessions directed to the handset whilst it is connected to the data network 8. Only in the event that the handset loses contact with all wireless access points 7, 17 will it re-establish communication with the nearest cellular base station 21, effecting a handover to that station which will be registered by the switching centre 2. The switching centre 2 reports to home network 18 that the mobile unit 1 has “roamed” onto the network 2.

In both embodiments, the provision of the handover facility 97, 98 within the packet data switching system results in a simplification of the interaction with the cellular network 2. The cellular network 2 can simply connect to the packet switched network 8 without needing to have visibility of how the user terminal is connected to it, and handovers between local wireless access terminals are handled without any involvement of the cellular system at all. In particular, handovers are possible even when the terminal is not in range of a cellular base station 21. The mobile switching centre 2 operates conventionally, with the interface 16 emulating a “roamed” handset throughout the time the handset is in communication with the local wireless access system.

1. A telecommunications switching system comprising location and switching means for routing communication sessions to and from a mobile terminal by way of an access network, wherein the access network comprises a plurality of access systems, each of which may be accessed by the mobile terminal,
interface means for communicating with a location and switching means of an associated network to report the establishment or cessation of a sessions between mobile terminals and the access network,
and handover means associated with the location and switching means to allow a mobile terminal to transfer from co-operation with one of the access systems directly to co-operation with another of the access systems, wherein the handover means of the access network operates independently of the associated network.

2. A switching system according to claim 1, wherein the interface means comprises means for connecting sessions between the associated network and a terminal connected to the access network.

3. A switching means according to claim 1, wherein the interface means comprises means for connecting sessions between the access network and a terminal connected to the associated network.

4. A switching means according to claim 3, comprising:
a register for recording the network locations of mobile terminals having identities allocated to the register, and
emulation means for reporting to the location means of the associated network when the mobile terminal is in communication with the access network,
arranged such that if a session attempt is directed to a terminal identity allocated to the register, and,
if the mobile terminal is currently associated with a connection to the access network, the switching means routes the session directly by way of the access network,
if the mobile terminal is not currently associated with a connection to the access network, the switching means attempts to route the session by way of the interface to the associated network, and the terminal is recorded by the register as being connected to the associated network.

5. A method of operating a telecommunications switching system such that communications sessions may be routed to and from a mobile terminal identity either by way of an access network or by way of an associated network,
wherein the access network comprises a plurality of access systems and a mobile terminal may be transferred, under the control of the access network, from co-operation with one access system to co-operation with another access system,
wherein the establishment or cessation of a session between a mobile terminal and the access network is reported to the associated network through an emulation means,
and wherein transfer between access systems during such a session is under the control of the access network and transparent to the associated network.

6. A method according to claim 5, wherein the interface means connects sessions between the associated network and a terminal connected to the access network.

7. A method according to claim 5, wherein the interface means connects sessions between the access network and a terminal connected to the associated network.

8. A method according to claim 7, wherein:
when a mobile terminal is in communication with the access network, this fact is reported to a location means of the associated network,
if a connection attempt is directed to a mobile terminal currently associated with a connection to the access network, the switching means routes the session directly by way of the access network, and
if the said mobile terminal is not currently associated with a connection to the access network, the switching means attempts to route the session by way of an interface to the associated network, and the terminal is recorded by the register as being connected to the associated network.
